(19) United States
(12) Patent Application Publication
(10) Pub. No.: US 2008/0038701 A1
(43) Pub. Date: Feb. 14, 2008

(54) TRAINING SYSTEM AND METHOD

(76) Inventors: Charles Booth, Birmingham, MI (US); David Hodgson, Rochester Hills, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/835,185

(22) Filed: Aug. 7, 2007

Related U.S. Application Data
(60) Provisional application No. 60/836,264, filed on Aug. 8, 2006.

(51) Int. Cl. G09B 19/00

(52) U.S. Cl. 434/219

(57) ABSTRACT

A method is disclosed for providing an immersive training environment for a user. A relaxation vignette is used and configured to facilitate learning by the user. A training vignette is provided and configured for emotionally and physically stimulating the user, the stimulation enhancing retention by the user. A system is disclosed that includes a relaxation vignette to prepare a user for learning. A training vignette emotionally and physically stimulates the user to enhance retention by the user. Both the relaxation vignette and the training vignette include a training system control module, an audio distribution module and a video distribution module.

### RELATED APPLICATIONS

The present application claims priority to Provisional Application Ser. No. 60/836,264, filed on Aug. 8, 2006, the contents of which are incorporated herein in their entirety.

### BACKGROUND INFORMATION

Training sessions are typically used to educate employees and test their knowledge of safe operating practices and bring safety into awareness. A typical training session begins with an announcement that the training will begin at a predetermined time. An employee that is to receive the training may or may not be forewarned of the training session. In many cases, training takes place in a room with a large number of people seated and watching a video. Moreover, the training itself may be provided as a short and direct teaching of a proper way of performing an act. For example, training may consist of reviewing a safety checklist. In another example, training may consist of watching a video that discusses safe operation of equipment (e.g., a forklift or a ladder).

### BRIEF DESCRIPTION OF THE DRAWINGS

FIG. 1 illustrates a system diagram of a training system, according to an embodiment.

FIG. 2 illustrates a training method, according to an embodiment.

FIG. 3 illustrates a recognition curve including experiential training, according to an embodiment.

FIG. 4 illustrates a flow diagram of a behavioral change model, according to an embodiment.

FIG. 5 illustrates a production method for an experiential film, according to an embodiment.

FIG. 6 illustrates a flow chart for retrofitting a known kiosk for use with experiential systems.

FIG. 7 illustrates a system diagram of a training method, according to an alternative embodiment.

FIG. 8 illustrates a flow diagram of a training method, according to the embodiment of FIG. 7.

FIG. 9 illustrates a flow diagram of an emotional/physical event catalyst to change an attitude.

FIG. 10 illustrates an embodiment of a first person changeover.

### DETAILED DESCRIPTION OF THE PREFERRED EMBODIMENTS

Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limit or restrict the invention to the precise form and configuration shown in the drawings and disclosed in the following detailed description.

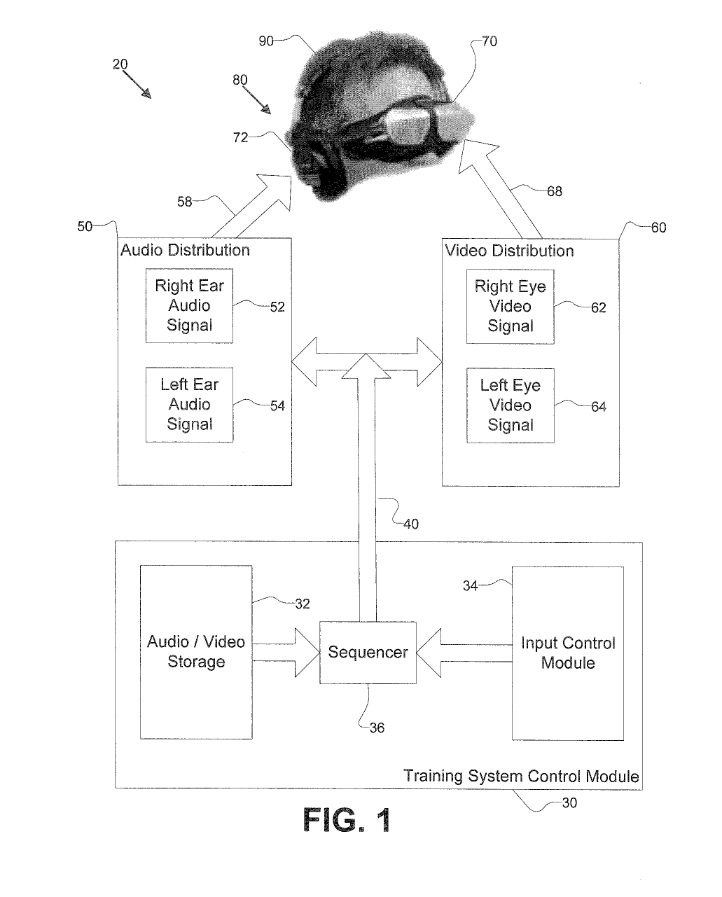

FIG. 1 illustrates a system diagram of a training system 20 according to an embodiment. Training system 20 includes a training system control module 30, an audio distribution module 50, a video distribution module 60, an earphone set 72, and a dual-pipe video display 70. The modules may be logical in nature sharing a common hardware platform (e.g., implemented in software) or actually distinct physical components. As shown, earphone set 72 and dual-pipe video display 70 are setup as a combined headset 80 worn by a user 90. However, earphone set 72 and dual-pipe video display 70 may be embodied as individual units worn by user 90.

Training system control module 30 includes audio/video storage 32, and input control module 34, and a sequencer 36. Sequencer 36 provides an audio/video output 40 to an audio distribution system 50 and a video distribution system 60. In an embodiment, the functions of sequencer 36 are performed entirely in software. Audio/video storage 32 is an interface to a storage device or a storage medium such as a hard-disk, a digital video disk (DVD), or a tape system, etc. Audio/video storage 32 includes segments of audio and video that, at least in part, include separate left and right audio and video channels. Where a compression system is used, the audio and video portions may be saved together but are able to be separated by way of an algorithm. Where audio/video storage 32 is embodied as a computer-related component, a database may further be used to store and allow retrieval by a key-based system. Input control module 34 may include a keyboard and/or dedicated button(s) that are used to begin, pause, and end the playback of the training session. Sequencer 36 retrieves audio/video from audio/video storage 32 for transmission to audio distribution system 50 and video distribution system 60 based on the status of input control module 34 or the status of the training session.

Audio distribution system 50 transmits audio to at least one headset 80. Separate outputs from sequencer 36 in the form of distinct audio signals 52, 54 are sent to headset 80 as separate audio channels via audio connector 58. Where there is a plurality of headsets 80, audio distribution system 50 amplifies and splits the audio portion of audio/video output 40 to each of the plurality of headsets 80. In an embodiment, audio distribution system 50 amplifies each of right ear audio signal 52 and left ear audio signal 54. Thus, headset 80 provides for stereo sound or more particularly, binural sound provided right ear audio signal 52 and left ear audio signal 54. The use of binural sound heightens emotional awareness and brings realism to simulated feelings.

Video distribution system 60 transmits video to at least one headset 80. Video signals 62, 64 are sent to headset 80 by way of sequencer 36 in one illustrated embodiment as separate video channels via video connector 68. Where there is a plurality of headsets 80, video distribution system 60 amplifies and splits the video portion of audio/video output 40 to each of the plurality of headsets 80. In an embodiment, video distribution system 60 amplifies each of right eye video signal 62 and left eye video signal 64. Each eye of user 90 is provided a different video image (i.e., right eye video signal 62 and left eye video signal 64) by way of dual-pipe video display 70 that has an individual left and right channel of video signal. The dual-pipe system allows for three-dimensional (3-D) viewing of source images or video. Thus, the presentation of video via headset 80 to user 90 is improved with the use of dual-pipe video.

Headset 80 is considered an immersive head-mounted-display (HMD) where headset 80 reduced or eliminates distractions to user 90. Headset 80 provides for a vivid and lifelike audio/visual environment. User 90 is immersed in an experience that engages audio and visual stimulus as well as triggering emotional responses through the realistic nature of the presentation and the content chosen. The 3-D stereoscopic video provided by dual-pipe video display 70 and earphone set 72 creates a vivid and lifelike visual environment that engages user 90 in an experience that emulates the human-natural experience of sight and sound.

In general, training system 20 provides for an immersive learning experience. The privacy and realism offered by user of headset 80 creates a productive learning environment by offering a personal viewing experience that enhances focus and reduced distraction. Moreover, the audio and video reproduced by headset 80 provides a genuine, warm, and realistic experience that feels as if it were happening live to user 90. The result is an emotionally engaging, multi-sensory experience leaving an unforgettable impression deep within the brain of user 90. Such experiences are long lasting and allow user 90 to naturally internalize the teachings of training system 20. Thus, training system 20 substantially facilitates the learning process.

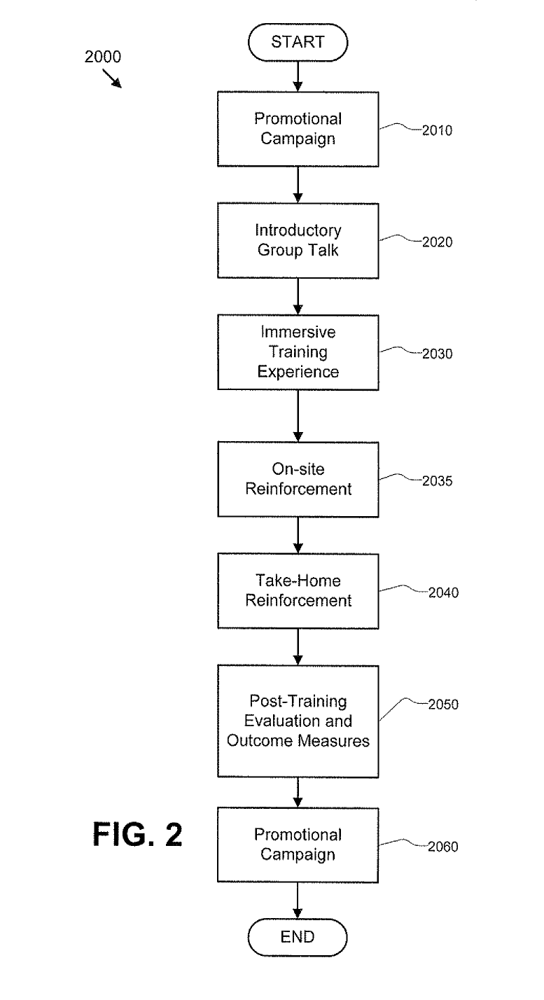

FIG. 2 illustrates a training method 2000, according to an embodiment. Training method 2000 may be tailored for each training scenario (e.g., safety, productivity, best practices, etc.). Training method 2000 begins at step 2010 where a promotional campaign is staged. The promotional campaign may include placement of posters, bulletins, and messages in locations where user 90 is likely to view them. The promotional campaign may be designed to instill a feeling of anticipation within user 90 that the training program will begin in the near future. Where user 90 is anticipating and looking forward to participating in training, user 90 is more likely to participate in the training with an open mind. Moreover, personal invitations may be given to user 90 to further engender a feeling of individuality in the training rather than a training “for the masses” approach. Training method 2000 continues to step 2020.

At step 2020, an introductory group talk is held. The group talk may include up to twenty (20) of users 90 in an embodiment. Although the number users 90 may be tailored for the particular application, a small number is preferred as at least one goal of the introductory group talk is to being leading user 90 to consider their own individuality and self worth. Thus, if a large number of users 90 are included in the group talk a feeling opposite of individuality may result from the large group. In an embodiment, a trained and certified facilitator presents an introductory speech and has an interactive discussion session with users 90 to bring about a sense of uniqueness and importance of each user 90. Through the discussion, users 90 are led to appreciate the importance of how important they are and that the choices they make will change not only their lives, but also the lives of the people user 90 cares about. In this way, users 90 are led to think about how the choices they make on a daily basis are one of the most important tools in protecting themselves. Moreover, the introductory session prepares users 90 for the immersive training experience to follow. Training method 2000 continues to step 2030.

At step 2030, an immersive training experience is used to train users 90 for a specific purpose using training system 20 (see FIG. 1). In an embodiment, the immersive training experience may be directed to shop safety, driving safety, or daily operations safety. The immersive training experience may also incorporate motivational psychology, adult learning principles, and brain-based learning techniques. Brain-based learning is a comprehensive approach to instruction directed to how current research in neuroscience suggests our brain learns naturally (e.g., learning directed to current knowledge about how the actual structure and function of the human brain learns). Thus, the brain-based techniques provide a biologically driven framework for teaching. Current research suggests that retention is high where a learning method connects teaching to the real-life experiences of the student (e.g., user 90).

In general, the teaching method of motivational psychology, adult learning principles, and brain-based learning techniques may include aspects of social relationships, external expectations, social welfare, personal development, escape/simulation, and cognitive interest. Using a social relationship aspect, the training may show making new friends, or meeting a need for associations and friendships. External expectations, may include complying with instructions of another, or fulfilling the expectations or recommendations of someone with formal authority. Social welfare teaching improves the ability to serve humankind as a whole. This may include preparing user 90 to prepare for service to the community and improve the ability to participate in community work. Aspects of personal development include goals such as achieving a higher status in a job, securing professional advancement, and keeping abreast of competitors. In using aspects of escape/simulation, user 90 is shown how to relieve boredom, provide a break in the routine of home or work, and provide a contrast to other exacting details of life. To inspire user 90 through cognitive interest, teaching techniques satisfy an inquiring mind but also allow for learning for the sake of learning.

The immersive training experience includes practical life experiences that are relevant to the everyday life of user 90 and uses powerful training vignettes that are designed to elicit emotional and/or physical responses from each user 90 to reinforce the training message (discusses in detail below). In general, each user 90 becomes part of a developmental story that demonstrates the cause and effect of every-day choices. The developmental story is experiential in nature because training system 20 is used. Moreover, as the vignettes unfold into a story line, the focus is on the responsibility and complete accountability of user 90 for their own actions (e.g., user 90 is completely accountable and responsible for their own actions with regard to personal safety). The vignettes are goal-oriented and incorporate self-directed elements that allow user 90 to conduct a portion of the training autonomously.

The immersive training experience creates a learning experience that shifts the focus of self-control to the individual user 90. At least one goal is to instill the importance of user 90 electing to be more responsible, situationally aware, and cautious in their day-to-day activities. Because, for example, personal safety is a decision made by user 90 as an individual, the message of the training experience is conveyed at a personal level. By way of using training system 20, user 90 is completely immersed in the training experience and disconnected from the surroundings of the training environment and other users 90. Training method 2000 continues to step 2040.

Next, in one illustrative illustration, at step 2035, the introductory group talk 2010 and immersive training experience 2030 may be further reinforced on-site by way of a further focused presentation. The presentation may be targeted to the particular facility or area of specialty of the participants. For example, if safety hazard identification is the focus of the teaching, a presentation using a tool such as Microsoft power point may be utilized. Such a tool helps students recognize safety hazards within their facility and to instruct them as to the proper reporting protocols specific to the facility or specialty are in the event that a hazard is identified or an accident takes place. It has been found that participants are particularly receptive to the more focused transfer of information after the immersive training experience set forth in step 2030.

At step 2040, an off-site or remote “take-home” reinforcement package is provided to user 90. The take-home package may include, for example, an audio compact disc (CD), a video (e.g., DVD or VHS tape), reading materials (e.g., books or handouts), or a three-dimensional video that allows user 90 to review the immersive training experience again. Another possibility may be a 3-D publication such as comic book, such as one in anaglyph three-dimensional format. Thus, optional three-dimensional input components are illustrated. It is envisioned that a comic book may be helpful with certain students that may have language challenges, lack equipment for viewing viewings, or need additional textual and visual reinforcement. Additionally, user 90 may share the training experience with family members to user as support and reinforcement of the message. A comic book may be particularly helpful when sharing the training experience with family members or friends and to place the experience in a non-threatening, but communicative context. When provided as a 3-D video, user 90 may view the training experience with similar effects, albeit with reduced fidelity as compared to training system 20.

By using the take-home portion, user 90 may improve the learned response by repetitive viewing and/or listening. Moreover, the take-home portion includes additional practice in using relaxation techniques. The relaxation techniques are a learned technique and are encouraged to be used daily to bring about a feeling of clam in body and mind of user 90. The benefits of relaxation allow for reduced tension and increased control in everyday life as well as during stressful situations. When stressful situations occur, the benefits of relaxation techniques allow user 90 to increased tolerance to stress and allows for improved decision making. In short, relaxation allows user 90 to handle situations without feeling overwhelmed or otherwise exhibiting stress-related physical symptoms (e.g., audio exclusion and tunnel vision). In this way, user 90 learns to more quickly respond and react to stressful situations in a calm, controlled, and rational manner. Thus, user 90 improves the ability to make better and safer choices. Training method 2000 continues to step 2050.

At step 2050, a post-training evaluation and outcome measurement takes place with respect to the entity (e.g., a company or an agency) providing training method 2000. The post-training evaluation is provided at the end of the immersive training experience of step 2030, after approximately forty five (45) days, after approximately one hundred eighty (180) days, and approximately after one (1) year. At least one purpose of the evaluation is to judge and measure the effectiveness of the immersive training experience. Given measurements taken from the day of the training, and at the periods mentioned above thereafter, the return on investment may be calculated for the entity providing the training. Training method 2000 continues to step 2060.

At step 2060, a post-program media promotional campaign is used to assist in sustaining the positive change in attitude and cultural impact of the immersive training experience. The post-program media campaign is used to support and reinforce the messages provided and may include posters and large format banners that will easily attract the attention of user 90. The campaign closely follows the messages provided to user 90 in the immersive training experience and may be displayed permanently in a facility. Thereafter training method 2000 ends. As described above, the steps may be performed in different orders. Moreover, steps may be added or omitted depending upon the custom training experience desired.

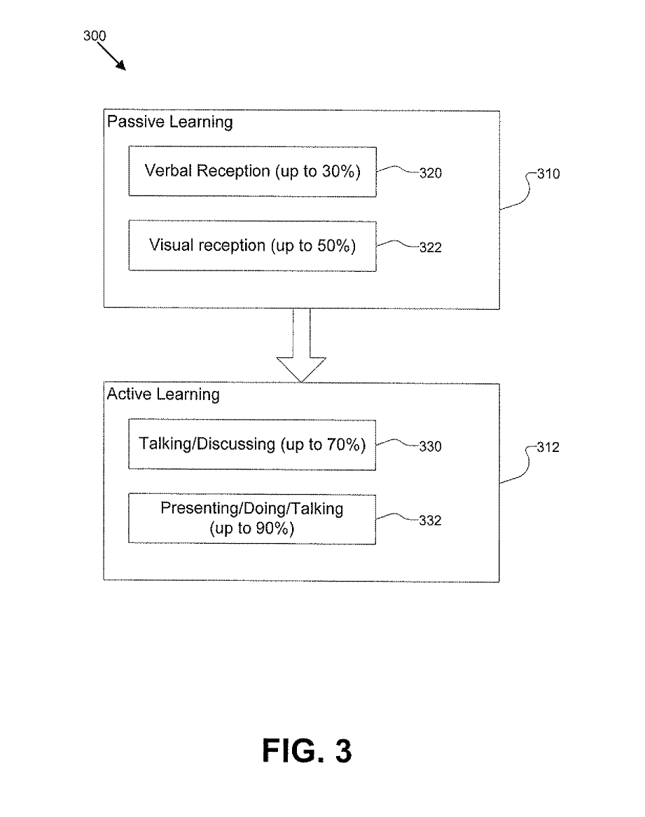

FIG. 3 illustrates a recognition curve 300 including experiential training, according to an embodiment. Recognition curve 300 shows the leaning potential of user 90 given different learning stimuli and includes a passive learning portion 310 and an active learning portion 312. Passive learning portion 310 includes a verbal reception component 320 (e.g., hearing) and a visual reception component 322 (e.g., sight). Active learning portion 312 includes a discussion segment 330 and a presentation segment 332. As shown in FIG. 3, the learning potential of verbal reception component 320 is up to thirty (30) percent, the learning potential of visual reception component 322 is up to fifty (50) percent, the learning potential of discussion segment 330 is up to seventy (70) percent, and the learning potential of presentation segment 332 is up to ninety (90) percent. Thus, it is clear that a training method using passive learning portion 310 is less effective than a training method using active learning portion 312. In a broader context, FIG. 3 shows that the more senses that are involved in the learning process, the greater the cognitive and emotional impact will result. In this way, training method 2000 using training system 20 provides a realistic and emotional learning environment that assists in retention and understanding of the training material.

When using training system 20 in light of the teachings of recognition curve 300, user 90 may develop habit-changing memories based on emotional and active participation in the learning process. Where emotion is stimulated and a physical response is elicited, learning is deeply rooted. An emotionally and physically engaging event is not easily forgotten. Moreover, these events may accelerate a behavioral change process because of the significant impact the emotional event has on the brain. When presented in a positive manner, the experience may be perceived by user 90 as a motivation or reason to make a change. Moreover, the event can trigger a lasting and positive change in the life of user 90. In an embodiment, such learning experiences can bring a safety training experience to life and change the habits of user 90 for the better to avoid future injury.

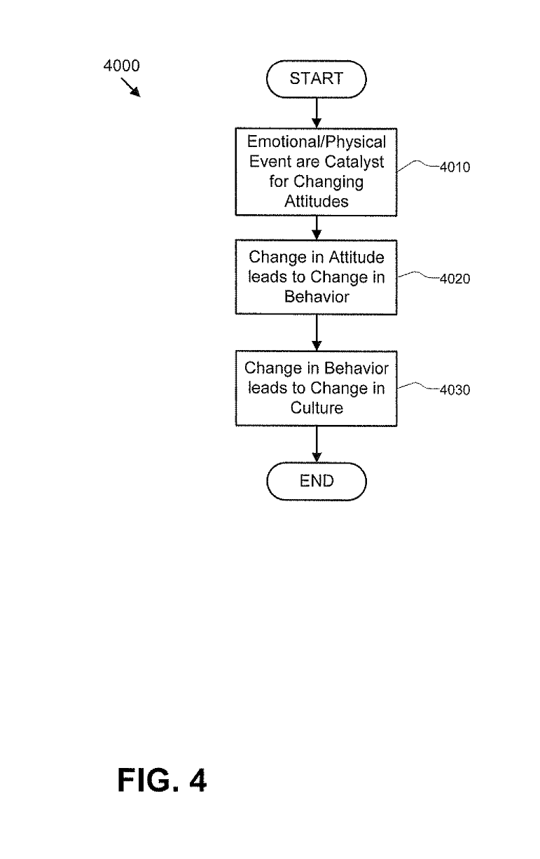

FIG. 4 illustrates a flow diagram of a behavioral change model 4000, according to an embodiment. In using training method 2000 and training system 20 a change in attitude, behavior, and culture may be instituted and reinforced within user 90, and extends to an entity as a whole where multiple users 90 are trained. Change model 4000 begins at step 4010 where emotional and physical events are used as a catalyst for changing attitudes of user 90. Behavioral change model 4000 continues with step 4020.

At step 4020, the emotional and physical events of step 4010 are recognized as leading to strongly internalized lessons. Thus, a change in behavior results due to the experienced emotional and/or physical events of step 4010. The personal responsibility taught and reinforced continues to change user 90 in that the every-day actions of user 90 are now influenced by the training. Behavioral change model 4000 continues with step 4020.

At step 4030, the change in attitude of user 90 results in a change in culture of an entity. Because multiple users 90 have been trained, and the training has resulted in behavioral change, the culture of users 90 has now been changed. Whereas a single user 90 may change personally, when training a multitude of users 90 changes the culture of a workplace or an entity in general. Behavioral change model 4000 then ends.

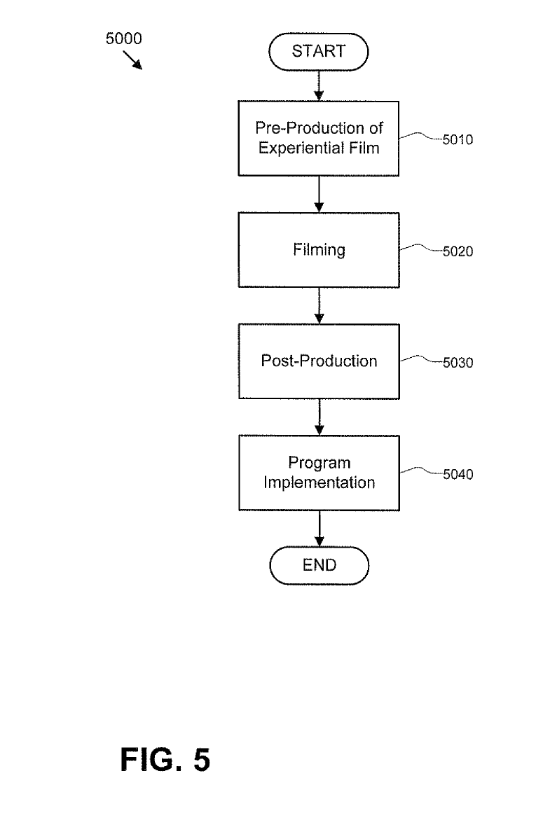

FIG. 5 illustrates a production method 5000 of an experiential film, according to an embodiment. Production method 5000 results in the creation of an experiential film for use with training method 2000 and training system 20, according to an embodiment. Production method 5000 begins at step 5010 where pre-production of an experiential film is performed. Pre-production may begin with a brainstorming session to develop concepts based on a desired outcome and setting. The target audience as well as the goals to be accomplished by the training should be clearly defined in order to produce a maximum effect story line. Moreover, a storyboard and script are developed to define the vignettes that will makeup the story line for use with training system 20. Production method 5000 proceeds to step 5020.

At step 5020, the filming of the experiential film is performed. Based on the storyboard and script developed in step 5010, the actors and situations are set-up and filmed. Additionally, the technical requirements for training system 20 are adhered to for maximum immersion of user 90 (e.g., stereoscopic filming and binural audio recording). Production method 5000 proceeds to step 5030.

At step 5030, postproduction is used to edit and conglomerate the various vignettes into a seamless presentation. Production method 5000 proceeds to step 5040.

At step 5040, program implementation is commenced where the presentation is provided using training system 20 to a user. Alternatively, program implementation may be performed by distributing the presentation to a plurality of training systems 20 to be experienced by users 90. Production method 5000 then ends.

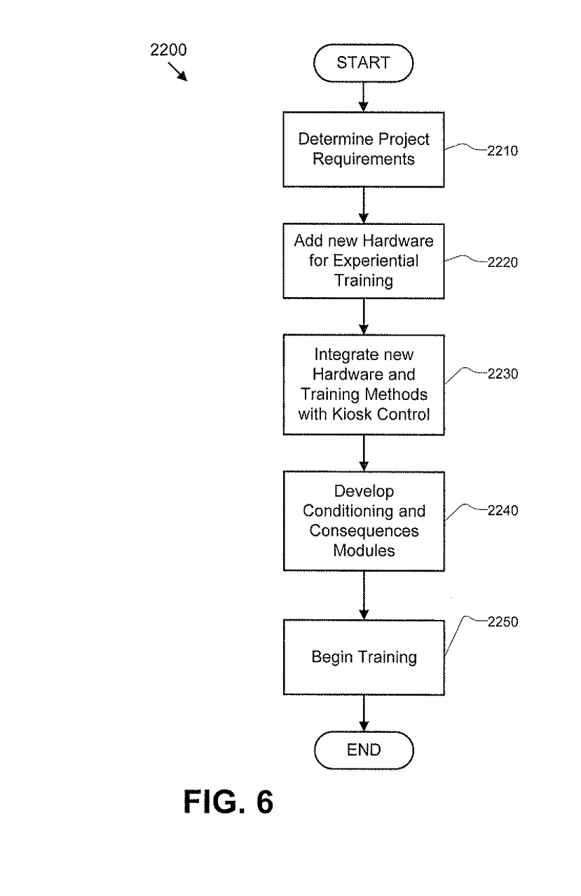

FIG. 6 illustrates a retrofitting method 2200 flow diagram for retrofitting a kiosk for use with experiential systems and training system 20. A kiosk may be a computer-driven training system wherein user 90 sits and watches a video. Retrofitting method 2200 provides a way to use existing infrastructure (e.g., a kiosk) with training system 20 and training method 2000. Retrofitting method 2200 begins at step 2210 where project requirements are determined. At this stage, customer requirements are defined and existing infrastructure is inventoried (including hardware and software) and assessed for functionality. Moreover, the interface requirements for addition of equipment and software may be determined. Retrofitting method 2200 continues at step 2220.

At step 2220, new hardware/software is added to the existing training systems (e.g., a kiosk). The new hardware may include some or all of the elements of training system 20. For example, depending upon system requirements, added components may be system control module 30, audio distribution system 50, video distribution system 60, earphone set 72, and dual-pipe video display 70, including headset 80. However, in an alternative embodiment, existing hardware may be used to provide the functionality of audio distribution system 50. Thus, audio processor need not be installed in hardware, but can be interfaced in software. For each of the systems described above, hardware and software may need to be upgraded and integrated. Retrofitting method 2200 continues at step 2230.

At step 2230, new hardware and software are integrated with the existing training infrastructure. In this step, certain existing hardware may require replacement or may be deprecated. Moreover, software integration with existing systems is required. Retrofitting method 2200 continues at step 2240.

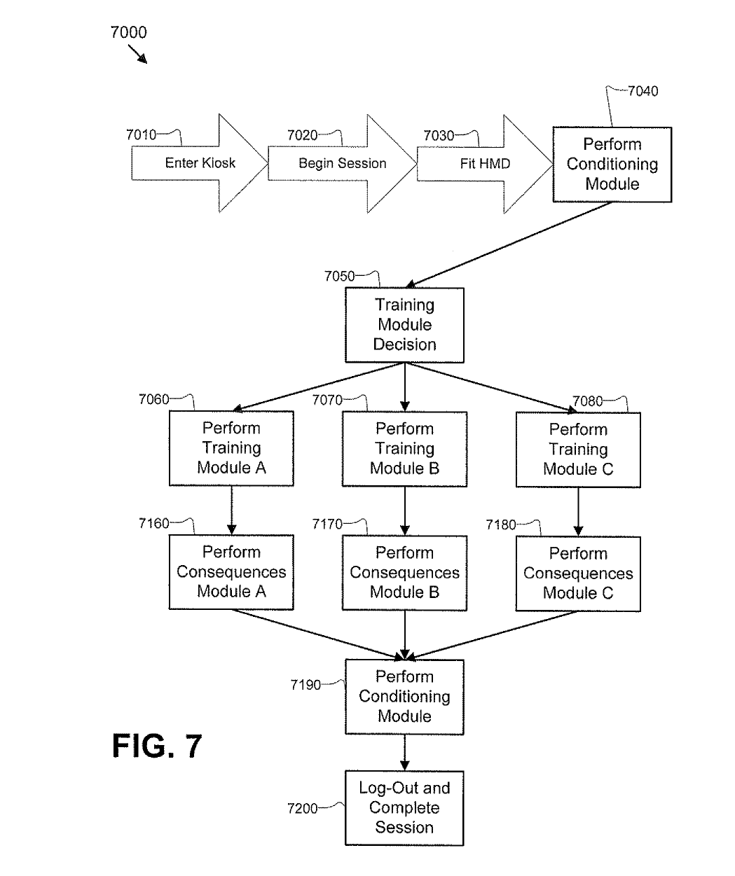

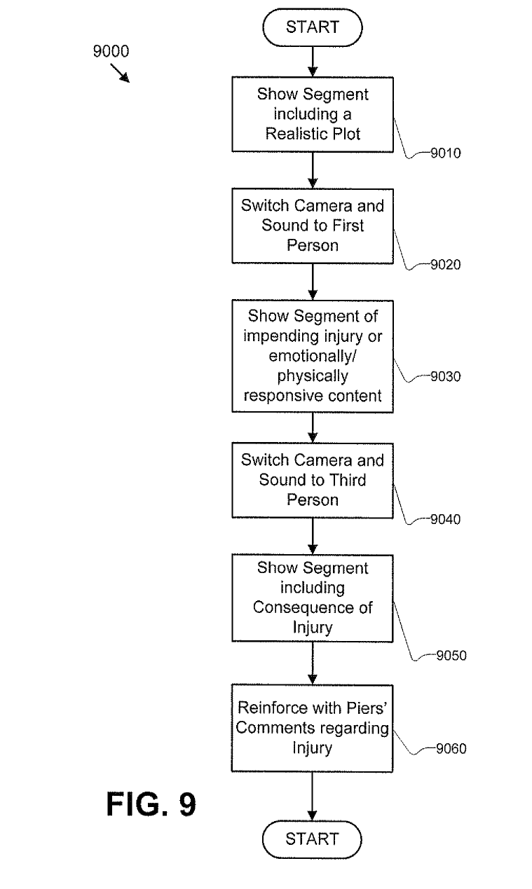

At step 2240, conditioning and consequences modules are developed for use with existing training modules (explained in detail below with respect to FIGS. 7 and 9). Retrofitting method 2200 continues at step 2250.

At step 2250, retrofitting of the existing infrastructure is complete, including hardware and software integration and development of new training modules. Thus, training commences using the retrofitted systems. Retrofitting method 2200 then ends.

FIG. 7 illustrates a system diagram of a training method 700, according to an alternative embodiment. Training method 7000 begins at step 7010 where user 90 enters a training kiosk. Training method 7000 continues at step 7020.

At step 7020, user 90 begins the training session by entering an identification name or number, according to an embodiment. Moreover, a kiosk information segment may be provided in which user 90 is instructed how to answer questions posed by the kiosk system using an input system (e.g., a keyboard). Once it is determined that user 90 is properly understanding and answering the questions (e.g., by answering all questions correctly), Training method 7000 continues at step 7030.

At step 7030, user 7030 is instructed to fit or don a head-mounted-display (HMD) such as combined headset 80. By providing the head-mounted-display, distractions during training are essentially eliminated. Training method 7000 continues at step 7040.

At step 7040, the training system performs a conditioning module. In one exemplary illustration the conditioning module lasts for approximately ten (10) minutes and is designed to prepare user 90 mentally, emotionally, and physically for the training experience. Indeed, a typical user 90 may have hundreds of thoughts or concerns that become distractions from the training experience. Thus, conditioning module helps user 90 relax, focus, and concentrate on the teaching aspects of training method 7000. The relaxation techniques taught in the condition module include, for example, deep breathing techniques. By using relaxation, the brain is conditioned in an alpha state and is more open to learning and behavioral change. Thus, relaxation and other techniques are used to increase the learning potential of user 90 during training method 7000. Moreover, the relaxation techniques are encouraged to be used in the daily life of user 90 to improve stress response and improve decision-making (explained in detail above). The conditioning module may also include a self-worth and choice/consequence introduction. The self-worth introduction may question user 90 to determine things that are important in their life, and the consequences that may occur if, for example, and injury were to happen to user 90. Additionally, the choice/consequence introduction may introduce the concept of personal responsibility and choice making as a way to reduce possible injury, in an embodiment.

In one alternative exemplary illustration, there are actually two conditioning modules. A first module is utilized at step 7040, but is abbreviated, for example, approximately three (3) minutes or so. However, there is a potentially a second conditioning module that is implemented at step 7190, just before step 7200 directed to Log-Out and Complete Session, as discussed in more detail below. If a latter conditioning module step 7190 is invoked, in one example, it extends for approximately five (5) minutes. The teachings are intended to be forcefully and clearly communicated, as discussed below. Thus, when invoked, a second conditioning module may help a student recover from the training exercise and to further absorb the teachings as transitioning back to the same state originally invoked in step 7040. Other conditioning modules may also be appropriately implemented as appropriate in the training system 20 and under some circumstances may be excluded all together, depending on the nature of the training experience and both the emotions and state of mind associated with the students.

If a conditioning module is implemented as shown at step 7040, training method 7000 continues at step 7050. At step 7050, a decision is made as to what training will be performed. In an embodiment, an automated system is pre-programmed to choose a training regime. In an alternative embodiment, user 90 may choose training regimes. In the present embodiment, three training regimes, A, B, and C, are available to be chosen. However, in alternative embodiments, a single training regime may be programmed. In yet another alternative embodiment, any number of training regimes may be allowed. Training method 7000 continues at step 7060, 7070, or 7080, depending upon whether training regime A, B, or C is chosen respectively.

At step 7060, training module A is shown to user 90. In this embodiment, a training sequence includes a forklift safety course in the immersive environment of training system 20. Training method 7000 continues at step 7160.

At step 7070, training module A is shown to user 90. In this embodiment, a training sequence includes a shop safety course in the immersive environment of training system 20. Training method 7000 continues at step 7170.

At step 7080, training module A is shown to user 90. In this embodiment, a training sequence includes a package moving safety course in the immersive environment of training system 20. Training method 7000 continues at step 7180.

At step 7160, a consequences module tailored for training module A (described in step 7060) is shown to user 90. The consequences module reinforces the training module in that the specific consequences for improper forklift safety are shown (e.g., a forklift accident and resulting injuries). Moreover, the consequences module is in part a first-person experience of the injuries that may result and the effect an accident has on the lives of user 90 as well as the lives of the family and friends of user 90. Training method 7000 continues at step 7200.

At step 7170, a consequences module tailored for training module B (described in step 7070) is shown to user 90. The consequences module reinforces the training module in that the specific consequences for improper shop safety are shown (e.g., loss of eyesight). Moreover, the consequences module is in part a first-person experience of the injuries that may result and the effect an accident has on the lives of user 90 as well as the lives of the family and friends of user 90. Training method 7000 continues at step 7200.

At step 7180, a consequences module tailored for training module C (described in step 7080) is shown to user 90. The consequences module reinforces the training module in that the specific consequences for improper package moving safety are shown (e.g., a back injury or crushed hand). Moreover, the consequences module is in part a first-person experience of the injuries that may result and the effect an accident has on the lives of user 90 as well as the lives of the family and friends of user 90. Training method 7000 continues at step 7200.

In general, steps 7160, 7170, and 7180 generally describe the consequences of poor decision making for the trained subject matter. The consequences modules allow user 90 to specifically and unequivocally understand the dangers and end result of bad safety decision making. The consequences are shown in “real-life” setting and are likely injuries that will result from poor safety choices. By way of illustrating the consequences in graphic detail, user 90 comes to understand that a choice that is apparently insignificant may have a permanent negative result (e.g., loss of vision, broken bones, injured back). Moreover, injures are shown using training system 20 (including headset 80) and include a realistic injury event as perceived by user 90. The consequences module is the pinnacle of the training session wherein user 90 is virtually injured and emotionally impacted by making an incorrect choice.

At step 7200, user 90 logs-out and the training session is complete.

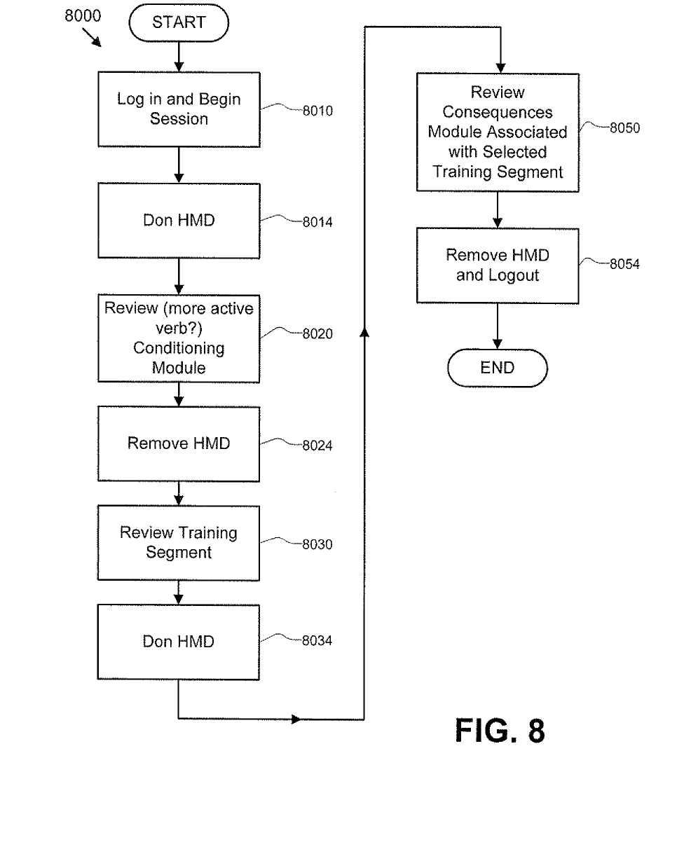

FIG. 8 illustrates a flow diagram of a training method 8000 according to an alternative embodiment wherein a head-mounted-display is used only for certain portions of the training presentation that are most benefited from an immersive environment. Thus, training method 8000 allows partial use of training system 20 while using existing infrastructure for reviewing the training segment. Training method 8000 begins at step 8010 where user 90 logs in and begins the training session. Training method 8000 continues at step 8014.

At step 8014, user 90 dons the head-mounted-display for an immersive experience. Training method 8000 continues at step 8020.

At step 8020, the conditioning module is shown in the immersive environment to user 90 (described in detail with respect to FIG. 7). Training method 8000 continues at step 8024.

At step 8024, user 90 takes off the head-mounted-display so that traditional kiosk-type training may take place. Training method 8000 continues at step 8030.

At step 8030, user 90 reviews the training segment using the kiosk display. In this case, the immersive training is not used for the skills teaching portion of the training presentation. This allows the existing infrastructure to be used with minimal modification and integration with training system 20 that includes immersion. When the training segment is complete, training method 8000 continues at step 8034.

At step 8034, user 90 again dons the head-mounted-display for further immersive experiences. Training method 8000 continues at step 8050.

At step 8050, user 90 reviews the consequences module for the associated training segment of step 8030 in an immersive environment. The specific consequences module may be selected automatically by the hardware/software of the kiosk or the consequences module may be selected by user 90. Training method 8000 continues at step 8054.

At step 8054, after the consequences module has been reviewed, user 90 removes the head-mounted-display and logs out of the training system. Training method 8000 then ends.

FIG. 9 illustrates a flow diagram of an emotional/physical event catalyst 9000 to change an attitude for use with training system 20 and training method 2000. By way of showing a sequence of events in a realistic fashion, the training method 2000 is enhanced in that the message and retention will be reinforced. Event catalyst 9000 begins at step 9010 where a realistic segment is shown to user 90 that mimics a realistic plot that may occur in the daily lives of user 90. In this step, user 90 sees the events as a third person viewer (e.g., the actor is seen by user 90 from the outside). Event catalyst 9000 continues at step 9020.

At step 9020, the camera angle switches to first person (e.g., user 90 sees through the eyes of the actor). This puts user 90 “in the shoes” of the actor. Event catalyst 9000 continues at step 9030.

At step 9030, an injury is virtually experienced by user 90. For example, a forklift may hit and run over user 90 in the first person. After the injury, the video may be absent (e.g., black screen) and hearing may be muffled. In an alternative embodiment, a metal chip may be expelled from a milling machine and come directly at the eye of user 90. In this case, eyesight is lost but hearing is normal. Thus, user 90 is not able to see the surroundings of the consequences module (e.g., the shop floor) but is able to hear the screams of coworkers that are attending to the virtual injuries of user 90. Event catalyst 9000 continues at step 9040.

At step 9040, the camera switches from first person to third person. Event catalyst 9000 continues at step 9050.

At step 9050, a segment is shown that demonstrates the consequences of the virtual injury. For example, the segment shows that the forklift accident kills the actor. In the alternative example, the metal chip has permanently blinded the actor. Here, the permanent consequences of incorrect safety choices are shown in explicit detail to user 90. The extreme and graphic nature of the injuries and consequences are intended to catch the attention of user 90 because of their grave nature. Event catalyst 9000 continues at step 9060.

At step 9060, the consequences are reinforced by comments by the actor's peers and family regarding the injury. In an embodiment, the actor's family is shown crying and attempting to make a plan for how to survive without the salary. In another embodiment, the segment shows the actor's friends discussing what the actor will do with the remainder of life without eyesight. Again the grave nature of the injuries is played upon to create an emotional event in a “what if that were me” scenario with user 90. Event catalyst 9000 then ends.

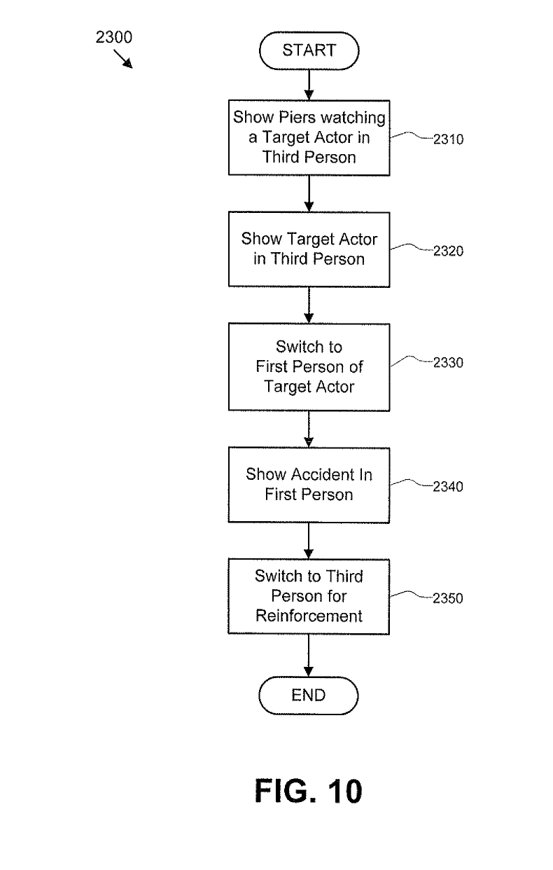

FIG. 10 illustrates an alternative embodiment of a first person changeover 2300. First person changeover 2300 begins at step 2310 where, in this embodiment, user 90 initially views in third person a group of peers watching the target actor. The peers comment on the poor safety choice the target actor is making. For example, the peers comment that the target actor is not following procedure and is not wearing safety glasses. First person changeover 2300 continues at step 2320.

At step 2320, user 90 sees the target actor in third person making a poor safety choice. For example, the target actor is operating a milling machine without safety glasses. First person changeover 2300 continues at step 2330.

At step 2330, user 90 is immediately switched to first person with the target actor. In this embodiment, user 90 now sees the milling machine in operation through the eyes of the target actor. First person changeover 2300 continues at step 2340.

At step 2340, an accident is shown to user 90 in first person. In this embodiment, the milling machine cuts a metal shaving from a work piece. Immediately, the metal shaving is hurled directly at the eyes of the target actor, and thus, virtually at the eyes of user 90. Provided training system 20 with the immersive headset 80, user 90 hears the metal shaving being torn from the work piece and sees in 3-D the metal shaving traveling at high speed toward the eyes of user 90. Thus, use of the immersive environment heightens the emotional and physical response of user 90. Here, a “flinch” is elicited from user 90 such that the feeling of the metal shaving traveling at the eyes of user 90 is highly realistic. In an embodiment, the injury may be substantiated by where user 90 cannot see (e.g., the screen is black) and user 90 hears an ambulance arriving and the screams of co-workers.

In yet another embodiment, user 90 experiences a virtual accident at the same time as viewing the same accident happening to a loved one. In this scenario, user 90 witnesses an automobile crash wherein user 90 is able to see both the accident happening to themselves as well as the accident injuring the loved one. In this sense, two points of view are conveyed to user 90. The first point of view is the first person witnessing of the crash scene happening to user 99 virtually. The second point of view, through the eyes of one crash victim, is the injuring of a family member. Such a multi-faceted approach allows for strong sight, sound, and emotional points of view to be addressed. First person changeover 2300 continues at step 2350.

At step 2350, the camera view is changes to third person for reinforcement of the injury occurring. User 90 sees the peers discussing the loss of eyesight of the target actor. First person changeover 2300 then ends.

With regard to the processes, methods, heuristics, etc. described herein, it should be understood that although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes described herein are provided for illustrating certain embodiments and should in no way be construed to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A method comprising:
providing an immersive training environment for a user;
providing a relaxation vignette;
configuring said relaxation vignette for facilitating learning by a user;
providing a training vignette; and
configuring said training vignette for emotionally and physically stimulating the user, said stimulation enhancing retention by the user.

2. The method of claim 1, said training vignette further comprising:
showing a third person scene;
showing a first person scene wherein a virtual event occurs to the user, said virtual event being configured for realistically triggering an emotional and physical response of the user.

3. The method of claim 2, wherein said virtual event is an injury.

4. The method of claim 1, including the staging of a promotional campaign for reinforcing said training vignette.

5. The method of claim 4, including a plurality of promotional campaigns, a first promotional campaign preceding said training vignette and a second promotional campaign succeeding said training vignette.

6. The method of claim 1, said relaxation vignette preceding said training vignette.

7. The method of claim 6, wherein there are a plurality of relaxing vignettes, a second vignette succeeding said training vignette.

8. The method of claim 1, wherein said immersive training environment includes three-dimensional video.

9. The method of claim 1, including reinforcing said training vignette at a location remote from said training vignette.

10. The method of claim 9, wherein said reinforcing includes a three-dimensional input component.

11. The method of claim 10, wherein said three-dimensional component includes one of a three-dimensional video and a three-dimensional book.

12. The method of claim 1, wherein said configuring including a first audio signal and a first video signal for stimulating one eye, and a second audio signal and a second video signal for stimulating a second eye.

13. A method comprising:
providing an immersive training environment for a user;
providing a relaxation vignette;
configuring said relaxation vignette for facilitating learning by a user;
providing a training vignette, said relaxation vignette preceding said training vignette;
configuring said training vignette for emotionally and physically stimulating the user, said stimulation enhancing retention by the user;
said training vignette showing a third person scene;
said training vignette further showing a first person scene wherein a virtual event occurs to the user;
said virtual event being configured for realistically triggering an emotional and physical response of the user;
reinforcing said training vignette at a location remote from said training vignette; and
staging a promotional campaign prior to said providing of said training environment.

14. The method of claim 13, wherein said configuring including a first audio signal and a first video signal for stimulating one eye, and a second audio signal and a second video signal for stimulating a second eye.

15. A system comprising:
a relaxation vignette to prepare a user for learning;
a training vignette for emotionally and physically stimulating the user and to enhance retention by the user; and
said relaxation vignette and said training vignette including
a training system control module,
an audio distribution module, and
a video distribution module.

16. The system of claim 15, said training system control module comprising:
an input control module;
a storage module; and
a sequencer, wherein said sequencer receives inputs from said input control module and said storage module.

17. The system of claim 16, wherein said storage module stores both audio and video, said sequencer has multiple outputs including a first audio signal and a first video signal for one eye, and a second audio signal and a second video signal for a second eye.

18. The system of claim 15, further comprising at least one promotional campaign for instilling a sense of anticipation towards said training vignette.

19. The system of claim 15, further comprising a reinforcement package distinct from said relaxation vignette and said training vignette.

20. The system of claim 15, said input control module including an input mechanism for beginning, pausing and ending the playback of said training vignette.
